(19) United States
(12) Patent Application Publication
(10) Pub. No.: US 2023/0066354 A1
(43) Pub. Date: Mar. 2, 2023

(54) RODENT TRAP

(71) Applicant: ANTICIMEX INNOVATION CENTER A/S, Helsinge (DK)

(72) Inventor: Kristian KISLING-MØLLER, Virum (DK)

(73) Assignee: ANTICIMEX INNOVATION CENTER A/S, Helsinge (DK)

(21) Appl. No.: 17/798,979

(22) PCT Filed: Feb. 12, 2021
(86) PCT No.: PCT/EP2021/053482

§ 371 Date: Aug. 11, 2022

(30) Foreign Application Priority Data
Feb. 14, 2020 (DK) PA202070085

(51) Int. Cl. A01M 23/16; A01M 23/30; A01M 23/38

(52) U.S. Cl. CPC A01M 23/16; A01M 23/30; A01M 23/38

(57) ABSTRACT

A rodent trap including a housing, an inner channel, a spring-loaded killing mechanism including at least one spring and at least one striker plate, a reloader, a trigger mechanism, and a bait. The housing includes an opening into the inner channel and one or more sensors arranged at/in the inner channel and/or the opening for triggering the trigger mechanism if a rodent is detected. The striker plate is configured to move between two positions by means of the spring, a first position in which at least a part of the striker plate is arranged at a first side of the inner channel and/or opening leaving the inner channel and/or opening open for passage.

### TECHNICAL FIELD

The present disclosure relates to a rodent trap. More specifically, the disclosure relates to a rodent trap as defined in the introductory parts of claim 1. The present disclosure relates to a trap for small animals, e.g. rats and mices, such as a spring-loaded strike trap.

### BACKGROUND ART

Within the area of rodent/rat traps there are many examples of different kind of such traps having different structures and functionality, such as spring-loaded strike or snap traps.

A problem with the solutions of the prior art traps, in particular, spring-loaded strike rat traps, among others, is that they are difficult to handle and require cumbersome ways of handling and arming as they often are complex in structure as being made up of many co-operating parts. A problem with the solutions of the prior art spring-loaded strike rat traps, among others, is that they are not able to accomplish a user friendly flexibility and more usable applications, and are not reliable enough in regard of unwanted triggering. A problem with the solutions of the prior art spring-loaded strike rat traps, among others, is that they are not able to accomplish a user friendly flexibility and more hygienic usability as, in some cases, the striker bar is arranged in a space that a user must access with the hands to arm the trap again after activation, which space may often be contaminated by the corpse of the rodent.

### SUMMARY

It is an object of the present disclosure to mitigate, alleviate or eliminate one or more of the above-identified deficiencies and disadvantages in the prior art and solve at least the above mentioned problem.

According to a first aspect there is provided a rodent trap comprising a housing, an inner channel, a spring-loaded killing mechanism comprising at least one spring and at least one striker plate, a reloader, a trigger mechanism, and a bait, the housing comprising an opening into the inner channel and one or more sensors arranged at/in the inner channel and/or the opening for triggering the trigger mechanism if a rodent is detected, the bait being arranged inside the inner channel, the striker plate being configured to move between two positions by means of the spring, a first position in which at least a part of the striker plate is arranged at a first side of the inner channel and/or opening leaving the inner channel and/or opening open for passage, characterized in that at least a part of the striker plate, in a second position, is arranged at a second side of the inner channel and/or opening being opposite the first side and that the movement of the striker plate between the two positions is a linear motion.

This provides a spring-loaded strike rat trap having a more efficiently used inner space as the striker plate requires less space for its movement. Hence, a more user friendly design of the spring-loaded strike rat trap in terms of accessibility is provided. This provides easier and more secure arming of the spring-loaded strike rat trap with less risk of injury in case of a “misfire” or accidental triggering while arming and/or having any body member, such as one or more fingers in contact with parts moving when the trap is triggered providing a more robust functionality and improved user safety.

According to some embodiments, the movement of the striker plate is in a direction essentially perpendicular to the extension of the inner channel.

This provides a more compact spring-loaded strike rat trap by more efficient use of its inner space as the movement of the killing striker plate “takes up” less volume inside the trap compared to a circular or curved/arched movement as in prior art rat traps.

According to some embodiments, the striker plate in the second position is configured to block/close at least a part of the inner channel and/or opening such that the rodent is unable to reach the bait through the inner channel/opening.

This provides an improved spring-loaded strike rat trap being more user friendly in terms of maintenance and bait life span as the bait is protected from being eaten by other rodents if the trap has been triggered as the bait is not accessible and the bait will be enough for a longer time before having to refill bait, whereby this also improves hygiene as less time and occasions for refilling is needed and due to the elimination of other still living rodents moving around and/or climbing on a dead one inside and around the trap.

According to some embodiments, the striker plate comprises an opening being aligned with the inner channel and/or opening (of the inner channel) when the striker plate is in its first position.

This provides an improved spring-loaded strike rat trap with a quicker killing ability as the killing striker plate “travels”, i.e. moves only a distance corresponding to the width and/or breadth and/or thickness of the inner channel and/or its opening before coming into contact with a rat if the trap is triggered. This also enables providing a better control, guidance and therefore improved stability of the movement of the killing striker plate when travelling back and forth during operation and use of the rat trap as more or longer guiding surfaces/parts are able to “hold” the killing striker plate in place during its movement.

According to some embodiments, the at least one spring is directly coupled to the striker plate.

This provides an improved spring-loaded strike rat trap with a quicker killing ability as the spring is in direct physical contact with the killing striker plate without any middle parts or components that add weight and/or play/slack and/or friction when transferring the movement and/or force and/or pressure from the spring to the striker plate.

According to some embodiments, the at least one spring is under compression when the striker plate is in its first position.

This provides a spring-loaded strike rat trap with a quicker and improved control of spring force and more robust killing ability as the spring is able to “react” swifter and with increased force and/or pressure earlier in its movement when the rat trap is triggered.

According to some embodiments, the reloader is configured to move the striker plate from its second position to its first position.

This provides a spring-loaded strike rat trap having a more user friendly design as the reloader enables easier arming without having to disassemble the trap. This provides easier arming of the spring-loaded strike rat trap as the reloader is able to work as a lever easing the load/effort of arming for a user. This provides more secure arming of the spring-loaded strike rat trap with less risk of injury in case of a “misfire” or accidental triggering while arming and/or having any body member, such as one or more fingers in contact with parts moving when the trap is triggered as the reloader enables eliminating direct physical contact with the striker plate when arming the trap, i.e. the hands of a user does not have to directly touch the striker plate during trap arming, instead the reloader is touched and used for arming, i.e. the reloader provides an intermediary aid similar to a prolongation of the hands of a user. This reloader provides a more robust functionality by acting as a safety and/or releasing and/or bypass of the force from the striker plate such that its force is not directly transferred to a user's hands if a faulty triggering of the trap occurs, e.g. during arming. This provides improved hygiene when handling the spring-loaded strike rat trap as any physical contact with parts that have been in contact with the dead rat is eliminated.

According to some embodiments, the reloader comprises a pusher part and a handle part, the pusher part being configured to push the striker plate from its second position to its first position by moving the handle part.

This provides a spring-loaded strike rat trap having a more user friendly design as the reloader enables easier arming without having to disassemble the trap. This provides easier arming of the spring-loaded strike rat trap as the reloader is able to work as a lever with handle for better grip easing the load/effort of arming for a user. This provides more secure arming of a spring-loaded strike rat trap with less risk of injury in case of a “misfire” or accidental triggering while arming and/or having any body member, such as a finger in contact with parts moving when the trap is triggered as the reloader pusher part and handle enable eliminating direct physical contact with the striker plate when arming the trap, i.e. the hands of a user does not have to directly touch the striker plate during trap arming, instead only the handle of the reloader is touched and used for arming, i.e. the reloader handle provides intermediary aid similar to prolonging the hands of a user. The pusher part and handle of the reloader provide more robust functionality by acting as a safety and/or releasing and/or bypass of the force from the striker plate such that its force is not directly transferred to a user's hands if a faulty trap triggering occurs. This provides improved hygiene when handling the trap as any physical contact with parts that have been in contact with the dead rat is eliminated.

According to some embodiments, the pusher part and the handle part are configured to be moved together in a linear motion.

This provides a spring-loaded strike rat trap having a more user friendly design as the pusher part and handle of the reloader enables easier access and enable using the same space for their movement as for the striker plate.

According to some embodiments, the pusher part and the handle part are configured to be moved together in a circular motion.

This provides a spring-loaded strike rat trap having a more user friendly design as the pusher part and handle of the reloader enable easier access from the outside of the trap with-out having to disassemble the trap to reach its interior. This pusher part and handle of the re-loader enable using gearing and/or a suitable loose tool, such as a torque spanner or wrench or the like for arming the trap instead of the hands or a handle fixedly attached to the trap for easing its arming.

According to some embodiments, the pusher part is connected to the striker plate.

This provides a spring-loaded strike rat trap having a more user friendly design as the pusher part of the reloader enable reducing the size of the space inside the trap required for the movement of the pusher part when arming the trap. The reloader pusher part enable reducing the number of parts required for arming. The pusher part is fixedly or movably or non-fixedly connected to the striker plate without any intermediary parts or entities.

According to some embodiments, the pusher part is disconnectable from the striker plate.

This provides more secure arming of a spring-loaded strike rat trap with less risk of injury in case of a “misfire” or accidental triggering while arming and/or having any body member, as no body part/finger is in contact with parts moving when the trap is triggered as the reloader pusher part enables eliminating direct physical contact with the striker plate when arming the trap. The reloader pusher part provides intermediary aid and leverage similar to prolonging the hands of a user while acting as a safety and/or releasing and/or bypass of the force from the striker plate such that its force is not directly transferred to a user's hands if a faulty trap triggering occurs. This provides improved hygiene when handling the trap as any physical contact with parts that have been in contact with the dead rat is eliminated.

According to some embodiments, the reloader comprises a spring for disconnecting and moving the pusher part from the striker plate.

This provides more secure arming of a spring-loaded strike rat trap with less risk of injury in case of a “misfire” or accidental triggering while arming and/or having any body member, such as a finger in contact with parts moving when the trap is triggered as the reloader pusher part is in principle autonomously/automatically moved “out of” direct physical contact with the striker plate after the trap is armed. Hence, the reloader pusher part provides a more robust and better user safety by being released from the striker plate without any action from the user, whereby the risk of any force from the striker plate being directly transferred to a user's hands via the pusher part if a faulty trap triggering occurs at or during or just after arming is further reduced or even eliminated. This provides improved hygiene when handling the trap as any physical contact with parts that have been in contact with the dead rat is eliminated.

According to some embodiments, the reloader spring is configured for retracting the handle part.

This provides more secure arming of a spring-loaded strike rat trap with less risk of injury in case of a “misfire” or accidental triggering while arming and/or having any body member, such as a finger in contact with parts moving when the trap is triggered as the reloader handle is in principle autonomously/automatically moved by the reloader spring into a safety position without contact with the pusher part and thereby the striker plate after the trap is armed. This reloader spring provides a more robust and better user safety by retracting and releasing the handle from the pusher part and the striker plate without any action from the user, whereby the risk of any force from the striker plate being directly transferred to a user's hands via the pusher part and further to the handle if a faulty trap triggering occurs at or during or just after arming is further reduced or even eliminated. This provides improved hygiene when handling the trap as any physical contact with parts that have been in contact with the dead rat is eliminated.

According to some embodiments, the reloader spring is operatively connected to a damper of the movement and retraction of the pusher and handle parts.

This provides even more secure arming of a spring-loaded strike rat trap with even less risk of injury in case of a “misfire” or accidental triggering while arming and/or having any body member, such as a finger in contact with parts moving when the trap is triggered as movement of the reloader pusher part and handle is damped when being moved by the reloader spring into a safety position with even less force or decreased speed of the movement, thereby further reducing the risk of injuries after the trap is armed. This reloader spring and damper provides a more robust and better user safety by retracting and releasing handle and pusher part from the striker plate in a smoother and slower way without any action from the user, whereby the risk of any force from the striker plate being directly transferred to a user's hands via the pusher part and the handle if a faulty trap triggering occurs at or during or just after arming is further reduced or eliminated. This provides increased life span for all moving parts as they move smoother and slower.

According to some embodiments, the striker plate comprises at least two ends of which a first inner end is configured to hit and kill a rodent in the second position after the rodent trap has been triggered and the striker plate has been moved from the first position to the second position.

This provides a spring-loaded strike rat trap having a more efficiently used inner space as the striker plate requires less space for its movement, arming and/or killing. A more user friendly design of the spring-loaded strike rat trap in terms of accessibility is provided. This provides easier and more secure arming of the spring-loaded strike rat trap with less risk of injury in case of a “misfire” or accidental triggering while arming and/or having any body member, such as one or more fingers in contact with parts moving when the trap is triggered, as the inner end of the striker plate is better shielded from access compared to if it was an outer end providing improved user safety.

According to some embodiments, the first inner end of the striker plate is configured with a rounded shape and/or blunt shape and/or obtuse-angled shape and/or an angled shape and/or pointed shape and/or sharp shape and/or sharp-edged shape and/or sharpened edge.

This provides a spring-loaded strike rat trap with a more efficient and optimised killing of rodents/rats. This provides a spring-loaded strike rat trap with less risk of injury in case of a “misfire” or accidental triggering while arming and/or having any body member, such as one or more fingers in contact with parts moving when the trap is triggered, as the inner end of the striker plate is shaped for improved user safety.

One or more embodiments provide/-s intermediary aid similar to prolonging the hands of a user by acting as a lever/lever arm while acting as a safety and/or releasing and/or bypass of the force from the striker plate such that its force is not directly transferred to a user's hands if a faulty trap triggering occurs.

The present disclosure will become apparent from the detailed description below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a perspective view of the front of the rodent trap according to an embodiment of the present disclosure.

FIG. 2 shows a perspective view slightly from above of the front of the rodent trap according to an embodiment of the present disclosure.

FIG. 3 shows a perspective view of the front of the rodent trap according to an embodiment of the present disclosure.

FIG. 4 shows a perspective view slightly from above of the back of the rodent trap according to an embodiment of the present disclosure.

FIG. 5 shows a perspective view slightly from above of the back of the rodent trap according to an embodiment of the present disclosure.

FIG. 6 shows a perspective view slightly from below of a lower of the back of the rodent trap according to an embodiment of the present disclosure.

FIG. 7 shows a perspective view slightly from below of the back of the rodent trap according to an embodiment of the present disclosure.

FIG. 8 shows a perspective view slightly from below of the back of the rodent trap according to an embodiment of the present disclosure.

FIG. 9 shows a planar side view of the back of the rodent trap according to an embodiment of the present disclosure.

FIG. 10 shows a planar side view of the back of the rodent trap according to an embodiment of the present disclosure.

FIG. 11 shows a planar side view of the back of the rodent trap according to an embodiment of the present disclosure.

FIG. 12 shows a planar side view of the back of the rodent trap according to an embodiment of the present disclosure.

FIG. 13 shows schematically a planar top view of the killing mechanism of the rodent trap when in its non-triggered state with solid lines and when in its triggered state in dotted lines according to an embodiment of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

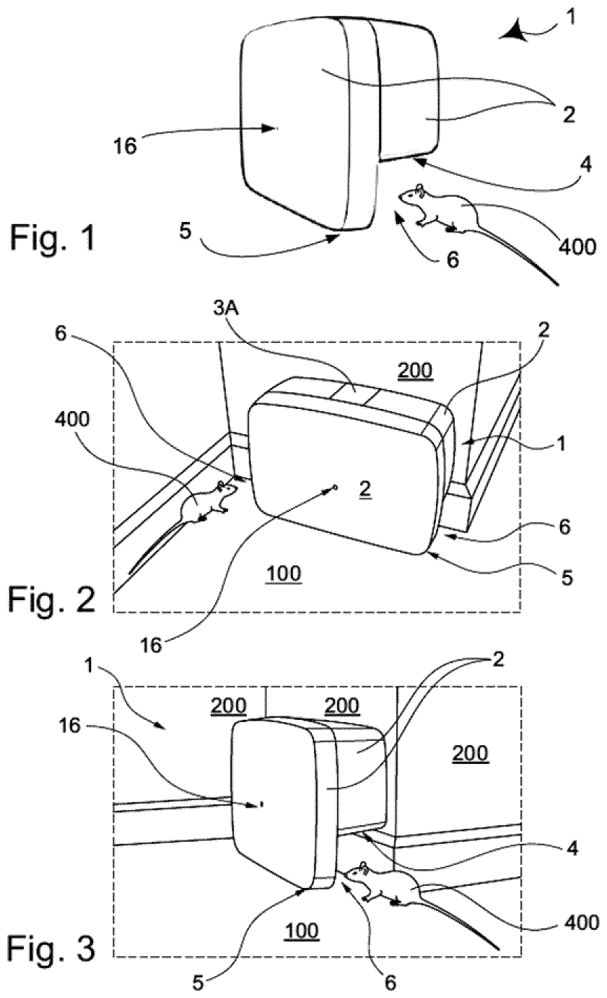

A rodent/rat trap 1 is shown in FIGS. 1-12 as examples/embodiments. The rodent or rat trap 1 comprises a housing 2 having at least one inner rat trap channel 3. In FIGS. 1-3, 7-8, and 10-12, at least one rat or mouse 400 is schematically visualised for easier understanding of the functionality of the rat trap 1. FIGS. 2 and 3 show an embodiment of the rat trap 1, wherein it is located at a floor 100 and up against a wall 200, e.g. as shown close to inner and outer corners of walls.

In an embodiment, the trap 1 is arranged on an essentially horizontal face or floor 100, and, as will appear from at least FIGS. 2 and 3, the trap 1 is arranged up against an inner wall or an outer wall 200. The trap comprises a trap housing 2 and a first flange 4 and a second flange 5. The flanges 4, 5 are connected substantially at right angles to the effect that the trap can be arranged in two positions where the wall 200 meets the floor 100. It is thus depicted in the position in which the trap housing 2 and its first flange 4 abuts on the wall 200, and the second flange 5 abuts on the floor 100, but it may, of course, also be located such that the trap housing 2 and its first flange 4 abuts on the floor 100, and the second flange 5 abuts on the wall 200. When the trap 1 is arranged in one of the two positions it is capable of occupying, with a flange 4, 5 in abutment on the wall 200, floor 100, wall 200, and flanges 4, 5 thus together span a passage 6 which an animal/rat/mouse 400 is capable of entering.

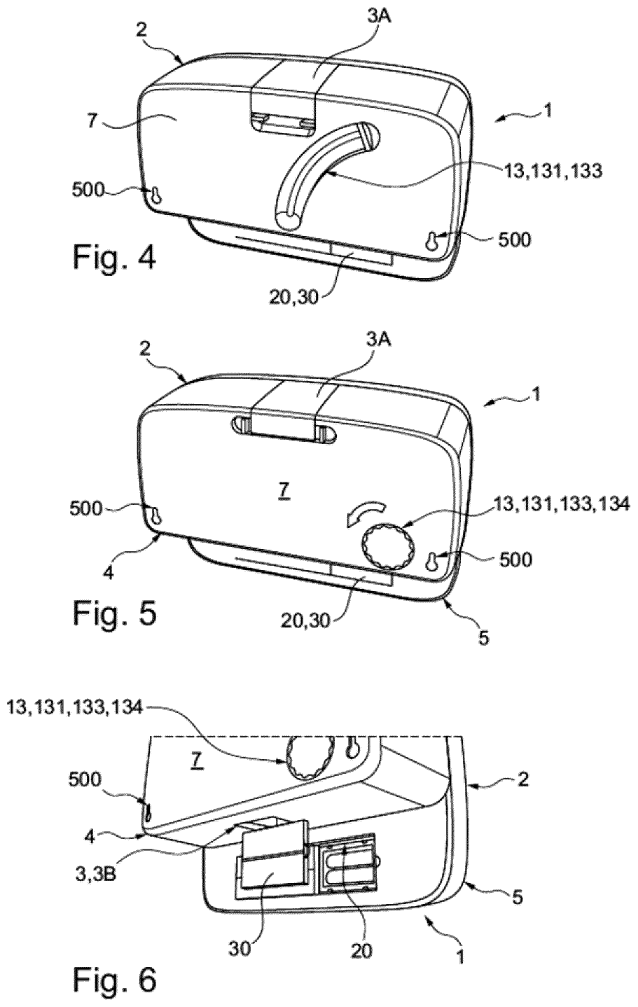

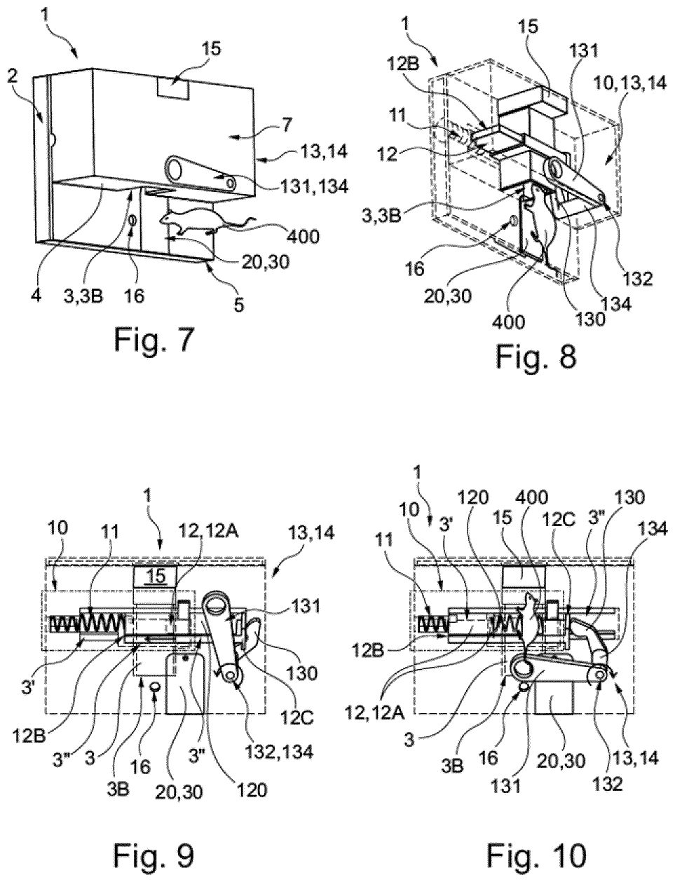

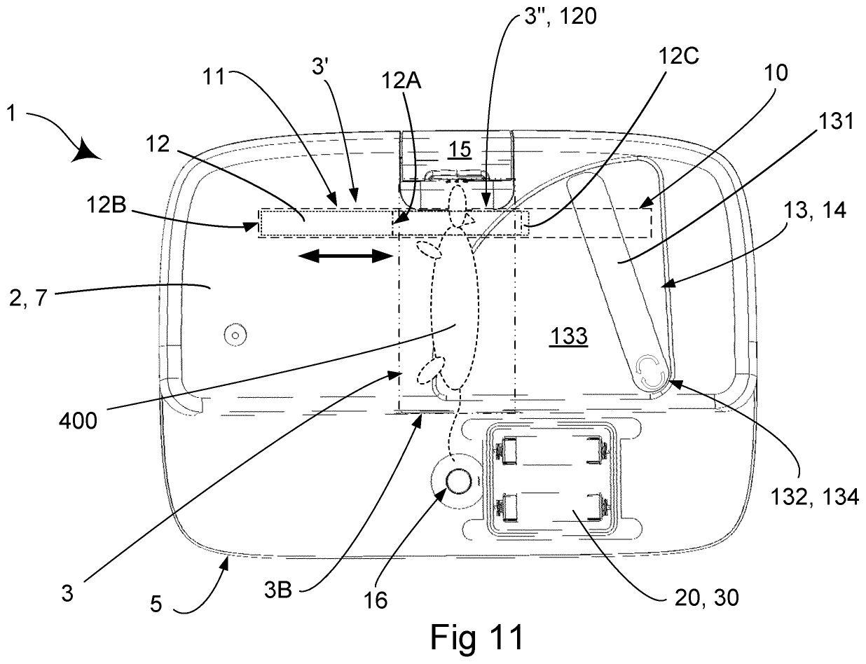

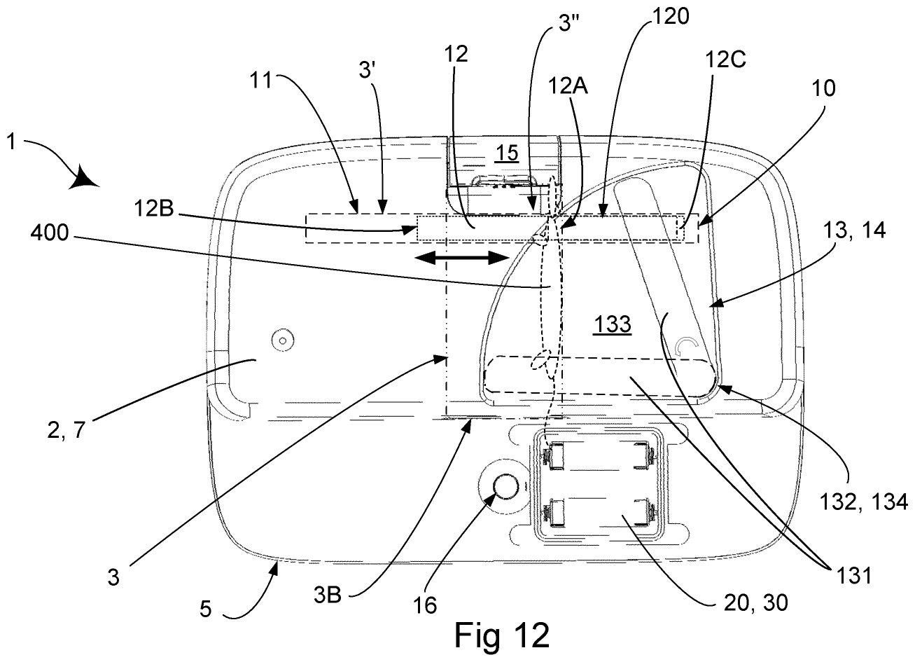

In an embodiment, the trap housing 2 comprises an inner passageway 3 which is best shown in FIGS. 7 to 12, where the trap 1 with a back 7 in FIG. 7 (the back 7 is transparent or removed in FIGS. 8 to 12) and is shown in perspective from below and from its back 7 in FIGS. 7 and 8 and shown with its inside in plane view from the back 7 in FIGS. 9 and 10 with a back plate removed or transparent revealing the inside and shown in schematical plane views from the back in FIGS. 11 and 12 without the back plate 7 removed to more clearly show its killing functionality and related motional pattern of the killing device 10. In an embodiment, one or more removable/detachable lids/covers 3A covers an upper part of the inner rat trap channel 3 as seen in FIGS. 2, 4 and. In an embodiment, the inner rat trap channel 3 comprises one or more openings 3B of its lower part/entrance/orifice as seen in FIGS. 6 to 10. One or more rats 400 is capable of progressing further into the opening 3B of that inner passageway 3 when it has entered the passage 6.

The rat trap 1 optionally includes a wireless communication unit, e.g. in the form of one or more radio chips connected to one or more antennas and configured to communicate wirelessly with other devices/rat traps 1, e.g. on the premises of and/or inside buildings, in a sewer system or the like.

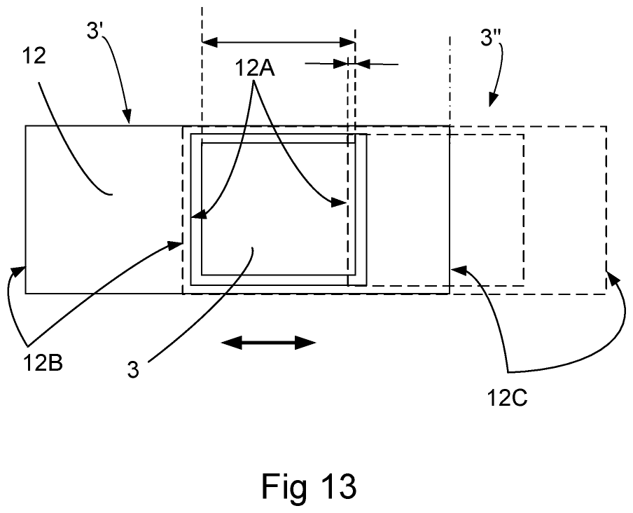

The first aspect of this disclosure shows the rodent trap 1 comprising the housing 2, the inner channel 3, and one or more spring-loaded killing mechanisms 10, each killing mechanism 10 comprising at least one spring 11 and at least one striker plate 12, at least one reloader 13, and at least one trigger mechanism 14. In an embodiment, the rodent trap 1 comprises one or more baits 15. In an embodiment, the housing 2 comprises the opening 3B into the inner channel 3 and one or more sensors 16 arranged at/in the inner channel and/or the opening for triggering the trigger mechanism if a rodent 400 is detected. In an embodiment, the bait 15 is arranged inside the inner channel 3 below the removable and/or detachable lid and/or cover 3A. In an embodiment, the striker plate 12 is configured to move between two positions 3′ and 3″ by means of the spring 11 urging the striker plate 12 from the first position 3′ into the second position 3″ in a very quick movement, see e.g. FIG. 13.

In FIGS. 4, 5 and 6, the trap 1 comprises one or more reloaders 13. Each reloader 13 comprises a pusher part 130 and a handle part 131 (see FIGS. 7 to 12). In FIGS. 8, 10, 11 and 12, the reloader 13 is shown comprising one or more reloading/retracting springs 132, which in an embodiment is part of the reloader in FIGS. 4 to 7. In FIGS. 4 to 6, 11 and 12, the reloader 13 is shown comprising one or more grooves or recesses 133 for the handle part 131 to move in or to be lowered flush with the housing surface of the trap 1 to not be a protruding part. In FIGS. 5 to 12, the rat trap 1 is shown with one or more axles 134 of the reloader 13. In FIGS. 7 to 12, the reloader 13 comprises one or more springs 132. The reloader spring 132 comprises and/or is operatively connected to a damper and/or a controller of the movement and retraction of the pusher and handle parts 130, 131 of the reloader 13.

In FIGS. 4 to 12, the rat trap 1 comprises one or more power sources 20. One or more or each power source 20 could be arranged in one or more battery compartments. One or more or all battery compartments 20 could be provided with a detachable power source/battery compartment lid/cover 30 as shown in FIGS. 4 to 12, where FIG. 6 shows the lid 30 when being removed/detached from the battery compartment and/or when being attached/put on/over the battery compartment/power source/-s 20 (FIGS. 11 and 12 show the battery compartment with the lid 30 removed).

In an embodiment, the striker plate 12 comprises at least two ends or preferably three ends 12A, 12B, 12C. A first end 12A is configured to hit and kill one or more rodents 400 in the second position 3″ after the rodent trap 1 has been triggered and the striker plate 12 has been moved, i.e. urged by one or more springs 11, from the first position 3′ to the second position 3″. In an embodiment, the first striker plate end 12A comprises or is made with a rounded shape and/or blunt shape and/or obtuse-angled shape and/or an angled shape and/or pointed shape and/or sharp shape and/or sharp-edged shape and/or sharpened edge, see e.g. FIG. 13.

In an embodiment, the striker plate 12 comprises at least two other ends 12B and 12C being the outer ends of the striker plate and the first striker plate end 12A being an inner end. This is in an embodiment done by making the striker plate similar to the beheading plate of a guillotine, but not that sharp and with a hole 120 made through it. In an embodiment, the inner end 12A forms at least a part of the inner circumference of this hole 120. In an embodiment, this hole 120 of the striker plate 12 is configured to be essentially aligned or substantially aligned or exactly aligned with the inner space of the inner channel 3 and/or its opening 3B when in its first position 3′ as shown in FIGS. 10, 11 and 13 in solid lines. In an embodiment, the striker plate 12 is moved or urged or pushed or pressed by the spring/-s 11 in an essentially and/or substantially perpendicular and/or exactly perpendicular direction relative the extension of the inner channel 3, similar to a knife cutting a loaf of bread across the bread, the inner channel 3 forming the bread and the striker plate 12 the knife, with the first inner end 12A of the striker plate 12 at least partly or fully crossing the inner space of the inner channel 3 as shown with bi-directional arrows in FIGS. 11, 12 and 13. In an embodiment, the outer ends 12B and 12C moves with the striker plate 12 but outside the inner channel 3 as shown at least in FIGS. 11 and 12. In an embodiment, the striker plate 12 comprises no hole 120 and comprises only the first end 12A as an outer end and the second end 12B still being an outer end as a design closer to a guillotine with a solid beheading plate, i.e. striker plate.

In one aspect, in the first position 3′, at least a part of the first end 12A and the second end 12B of the striker plate 12 is arranged at a first side of the inner channel 3 and/or opening 3B leaving the inner channel and/or opening open for passage, this is shown in FIGS. 8, 10, 11, 12 and 13 in solid lines and also visualized in FIG. 13 by the two upper arrows where the double arrow shows the “open” size or width or opening of the inner channel 3 after having armed the rat trap 1. The other two upper arrows pointing towards each other in FIG. 13 visualises the “closed” size or width, i.e. the closed or cutoff inner channel 3, which could be “zero” or fully closed but is at least of a size being so small that a rodent 400 is quickly killed by being forcibly pressed therein when the trap 1 has been triggered as seen in dotted lines in FIG. 13. In one aspect, at least a part of the first end 12A and/or the third end 12C of the striker plate 12, in the second position 3″, is arranged at and/or close to and/or adjacent and/or on and/or past and/or beyond a second side of the inner channel 3 and/or opening 3B being opposite the first side as shown in FIGS. 9, 12 and 13 after the trap 1 has been triggered. The movement of the handle 131 is shown in FIG. 12 by visualizing two positions for it, a start/ready position in solid lines (this position is also shown in FIG. 11) and an arming position in dashed lines. The reloader handle 131 is moved from the right start or ready position shown in solid lines in FIGS. 11 and 12 to the lowered arming position in FIG. 12 shown in dashed lines to arm the rat trap 1. In an aspect, the handle 131 is then after arming moved back to the start/ready position shown in solid lines in FIGS. 11 and 12 from the armed position shown in dashed lines in FIG. 12 by use of biasing, e.g. via one or more of the springs 132. In one aspect, the movement of the striker plate 12 between the two positions 3′, 3″ is a linear motion as shown with the straight bi-directional arrows of FIGS. 11, 12 and 13 (lower arrow in FIG. 13). In an aspect, the movement of the striker plate 12 visualised by the bi-directional arrows in FIGS. 11, 12 and 13 is in a direction essentially perpendicular to the extension of the inner channel 3 as seen in these figs. In an aspect, the striker plate 12 in the second position 3″ blocks/closes at least a part of the inner channel 3 and/or opening 3B or closes it fully, such that a rodent 400 is unable to reach the bait 15 through the inner channel/opening.

In an example embodiment, the at least one spring 11 is directly coupled to the striker plate 12 as seen in FIGS. 8 to 10. In an embodiment, the at least one spring 11 is under compression when the striker plate 12 is in its first position 3′ as shown in FIGS. 8, 10, 11 and 13. In an embodiment, the reloader 13 when moved/used/pushed by a user and/or biasing by means of a spring or the like moves the striker plate 12 from its second or triggered position 3″ shown in FIGS. 9, 12 and 13 (in dotted lines in FIG. 13) to its first start or ready position 3′ shown in FIGS. 8, 10, 11 and 13 (in solid lines in FIG. 13). In an embodiment, the reloader 13 comprises at least one pusher part 130 and at least one handle part 131. In an embodiment, the reloader pusher part 130 is configured to push the striker plate 12 and its first inner end 12A from its second or triggered position 3″ shown in FIGS. 8, 12 and 13 to its first or start or ready position 3′ shown in FIGS. 8, 10, 11 and 13 by moving the handle part 131 from the start or ready position shown in solid lines in FIGS. 8, 9 and 11 downwards to the left in a curved counter-clockwise movement to its arming position shown in solid lines in FIGS. 7, 8 and 10 and shown in dashed lines in FIG. 12. Thereafter the handle part 131 is moved upwards in a curved clockwise direction back to the ready position in FIGS. 9, 11 and 12 shown in solid lines. In FIGS. 5 and 6, the handle 131 is rotated or turned counter-clockwise for arming the trap 1 and is rotated or turned clockwise when returning, i.e. being retracted back to its ready position in FIGS. 9, 11 and 12 shown in solid lines (with or without help of biasing of spring/-s 132). In FIGS. 5 and 6, the handle 131 is shown as a turnable knob instead of a lever as in FIGS. 4 and 7 to 12. The knob handle 131 has in an embodiment as shown in FIGS. 5 and 6 a shape fitting into a socket of a wrench or the like. In an embodiment, the shape of the knob or handle 131 in FIGS. 5 and 6 could be specifically designed to fit into a certain socket of a wrench, e.g. a non-standard one, so that only a buyer of the rat trap 1 or an employed fitter of the rat trap manufacturer could be able to arm the rat trap 1 by using a special socket.

In an embodiment (not shown) the pusher part 130 and the handle part 131 move together in a linear motion when the striker plate 12 moves and/or when the rat trap 1 is armed. In an embodiment, as shown in FIGS. 4 to 12, the pusher 130 and the handle 131 move together in a circular motion when the rat trap 1 is armed. In an embodiment, the pusher part 130 is connected to the striker plate 12. In an embodiment as shown in FIGS. 9 and 10, the pusher part 130 is disconnectable from the striker plate 12. In an embodiment, the reloader 13 comprises one or more of the springs 132 for disconnecting and moving the pusher part 130 from the striker plate 12 together with the handle 131. In an embodiment, the reloader spring 132 is operatively connected to a damper of the movement and retraction of the pusher and handle parts 130, 131.

The person skilled in the art realizes that the present disclosure is not limited to the preferred embodiments described above. The person skilled in the art further realizes that modifications and variations are possible within the scope of the appended claims. For example, the lever or knob 131 could be arranged at another side of the rat trap 1 instead of the back 7, e.g. at the front shown in FIG. 2 and/or any of its sides, e.g. any of the sides to the right or left in FIGS. 1 and 3 and/or any of the sides to the left or right in FIGS. 7 and 8, and/or at any long and/or short side and/or at the top and/or bottom, if applicable, e.g. if turned upside down or turned 90°, 180° or 270° or with any other angle in any direction. Additionally, variations to the disclosed embodiments can be understood and effected by the skilled person in practicing the claimed disclosure, from a study of the drawings, the disclosure, and the appended claims.

1. (canceled)

2. The rodent trap according to claim 12, wherein
the movement of the at least one striker plate is in a direction essentially perpendicular to an extension of the inner channel.

3. The rodent trap according to claim 12, wherein the at least one striker plate in the second position is configured to block/close at least a part of the inner channel and/or opening such that the rodent is unable to reach the bait through the inner channel/opening.

4. The rodent trap according to claim 12, wherein the at least one striker plate comprises an opening being aligned with the inner channel and/or opening when the at least one striker plate is in the first position.

5. The rodent trap according to claim 12, wherein the at least one spring is directly coupled to the at least one striker plate.

6. The rodent trap according to claim 15, wherein the at least one spring is under compression when the at least one striker plate is in the first position.

7. The rodent trap according to claim 12, wherein the reloader is configured to move the at least one striker plate from the second position to the first position.

8. (canceled)

9. The rodent trap according to claim 12, wherein the pusher part and the handle part are configured to be moved together in a linear motion.

10. The rodent trap according to claim 12, wherein the pusher part and the handle part are configured to be moved together in a circular motion.

11. (canceled)

12. A rodent trap comprising:
a housing;
an inner channel;
a spring-loaded killing mechanism comprising:
at least one spring; and
at least one striker plate;
a reloader;
a trigger mechanism; and
a bait
wherein the housing comprises:
an opening into the inner channel; and
one or more sensors arranged at/in the inner channel and/or the opening for triggering the trigger mechanism if a rodent is detected;
wherein the bait is arranged inside the inner channel, and wherein the at least one striker plate being configured to provide movement between a first position and a second position via the spring, wherein at the first position at least a part of the at least one striker plate is arranged at a first side of the inner channel and/or an opening leaving the inner channel and/or an opening open for passage;
wherein at least a part of the at least one striker plate, in the second position, is arranged at a second side of the inner channel and/or an opening being opposite the first side of the inner channel and that the movement of the at least one striker plate between the first position and the second position is a linear motion;
wherein the reloader comprises a pusher part and a handle part, the pusher part being configured to push the at least one striker plate from the second position to the first position by moving the handle part;
wherein the pusher part is connected to the at least one striker plate and is disconnectable from the at least one striker plate (12).

13. The rodent trap according to claim 12, wherein the reloader comprises a spring for disconnecting and moving the pusher part from the at least one striker plate.

14. The rodent trap according to claim 13, wherein the spring of the reloader is configured for retracting the handle part.

15. The rodent trap according to claim 14, wherein the spring of the reloader is operatively connected to a damper of the movement and retraction of the pusher part and the handle part.

16. The rodent trap according to claim 12, wherein the at least one striker plate comprises at least two ends of which a first inner end is configured to hit and kill the rodent in the second position after the rodent trap has been triggered and the at least one striker plate has been moved from the first position to the second position.

17. The rodent trap according to claim 16, wherein the first inner end of the at least one striker plate is configured with a rounded shape and/or blunt shape and/or obtuse-angled shape and/or an angled shape and/or pointed shape and/or sharp shape and/or sharp-edged shape and/or sharpened edge.

18. The rodent trap according to claim 2, wherein the reloader is configured to move the at least one striker plate from the second position to the first position.

19. The rodent trap according to claim 2, wherein the at least one striker plate comprises at least two ends of which a first inner end is configured to hit and kill the rodent in the second position after the rodent trap has been triggered and the at least one striker plate has been moved from the first position to the second position.

20. The rodent trap according to claim 13, wherein the at least one striker plate comprises at least two ends of which a first inner end is configured to hit and kill the rodent in the second position after the rodent trap has been triggered and the at least one striker plate has been moved from the first position to the second position.

21. The rodent trap according to claim 14, wherein the at least one striker plate comprises at least two ends of which a first inner end is configured to hit and kill the rodent in the second position after the rodent trap has been triggered and the at least one striker plate has been moved from the first position to the second position.
